(19) United States
(12) Patent Application Publication
(10) Pub. No.: US 2025/0388996 A1
(43) Pub. Date: Dec. 25, 2025

(54) A PROCESS FOR TREATING IMPURITY CONTAINING STREAMS

(71) Applicant: VIRIDIAN LITHIUM S.A.S., Strasbourg (FR)

(72) Inventors: Jon STARINK, Subiaco (AU); David MAREE, Subiaco (AU)

(73) Assignee: VIRIDIAN LITHIUM S.A.S., Strasbourg (FR)

(21) Appl. No.: 18/879,218

(22) PCT Filed: Jun. 21, 2023
(86) PCT No.: PCT/AU2023/050560

§ 371 Date: Dec. 26, 2024

(30) Foreign Application Priority Data
Jun. 29, 2022 (AU) 2022901813

(51) Int. Cl. C22B 26/12; C01D 15/06; C01D 15/08; C22B 1/02; C22B 3/08; C22B 3/10

(52) U.S. Cl. CPC C22B 26/12; C01D 15/06; C01D 15/08; C22B 1/02; C22B 3/08; C22B 3/10

(57) ABSTRACT

A process (100) for treating aqueous impurity containing streams containing lithium cations and impurities within a lithium extraction process comprises: (a) contacting the impurity containing stream with a soluble phosphate to produce a precipitate containing lithium phosphate and a soluble impurity containing stream; and (b) treating the precipitate containing lithium phosphate with an aqueous reagent to produce the soluble phosphate for re-use in step (a) and a lithium salt recyclable to the lithium extraction process (100). Lithium recovery from the impurity containing stream may be 80% or greater.

### TECHNICAL FIELD

The present invention relates to a process for treating impurity containing streams, in particular to impurity containing streams within a lithium extraction process.

### BACKGROUND ART

The following discussion of the background art is intended to facilitate an understanding of the present invention only. The discussion is not an acknowledgement or admission that any of the material referred to is or was part of the common general knowledge as at the priority date of the application.

Lithium salts—in particular lithium hydroxide, lithium carbonate and lithium phosphate—are currently in high demand for production of batteries to be used for electrical vehicles and other applications.

Lithium may be extracted from its ores by a range of hydrometallurgical processes to produce lithium salts. More modern processes involve recycling of process streams such as the leaching reagent. Over time, impurities—such as alkali, alkaline earth, transition metals or heavy metals can build up in the recycled streams and these impurities require removal or reduction to an acceptable level to avoid disruption of the extraction process.

With a high value for lithium salts, losses of lithium from a lithium extraction process circuit are undesirable. However, this conflicts with the need for removal of impurities, of which there are many but sodium and potassium are important examples, from that process circuit that can affect the specification of the product lithium salt. Impurities are typically removed from a lithium process circuit by removing an impurity containing stream, also known as a bleed stream, from that circuit. Although a bleed stream typically contains a small mass of lithium due to an efficient lithium extraction process, lithium is often contained, at some concentration, in such a bleed stream and this creates loss of lithium and possibly other values as well.

The environmental unacceptability of lithium in discharge water streams can also be noted so there is an imperative to address a combination of issues in lithium recovery, lithium specification and environmental challenges to lithium in aqueous streams directed—if at all—to the environment.

It is against this background that the process of the present invention has been developed.

### SUMMARY OF INVENTION

The present invention provides, in one aspect, a process for treating aqueous impurity containing streams containing lithium cations and impurities within a lithium extraction process comprising:
(a) contacting the aqueous impurity containing stream with a soluble phosphate to produce a precipitate containing lithium phosphate and a soluble impurity containing stream; and
(b) treating the precipitate containing lithium phosphate with an aqueous reagent to produce the soluble phosphate for re-use in step (a) and a lithium salt recyclable to the lithium extraction process.

Desirably, the impurity containing stream is a stream—also called a “bleed stream”—removed from the lithium extraction process for the purposes of reducing impurity build up in a lithium extraction process circuit, in particular, where streams are recirculated through the lithium extraction process. A bleed stream may also be taken where, for example, a process stream is contaminated with impurities due to a process control problem such as poor control over pH. A bleed stream is typically produced downstream of a leaching step for lithium extraction.

Typically, but not exclusively, the impurity containing stream contains a plurality of impurity cations such as potassium, sodium, rubidium, caesium and other metals other than lithium; and counter-anions selected from the group consisting of carbonate, bicarbonate, sulphate, bisulphate, sulphide, sulphite, hydroxide, chloride, fluoride, bromide, hydrogen or dihydrogen phosphate, nitrate, thiosulphate, perchlorate, iodate, chlorate, bromate, chlorite, cyanide, amide, cyanate, peroxide, thiocyanate, oxalate, hypochlorite, and hypobromite. In the bleed stream, the cations other than lithium are impurities; and, other than carbonate, most of these counter-anions are impurities. Bleed streams are typically diverted from main process streams at various locations in the lithium extraction processing circuit.

Where lithium concentration in the impurity containing stream is above a threshold, conveniently corresponding with the lithium carbonate solubility at the temperature of the impurity containing stream, the impurity containing stream is treated with a first precipitant prior to step (a) to produce a precipitate containing a lithium salt, conveniently lithium carbonate. In the case for lower pH solutions, such as sulphate or chloride systems typically having a pH of less than 9, the first precipitant is conveniently a carbonate, conveniently sodium carbonate. In the case for higher pH solutions, such as hydroxide systems typically having a pH of above 9, the precipitant may be carbon dioxide gas.

Where lithium concentration in the impurity containing stream is below the upper lithium concentration threshold, conveniently corresponding with the lithium carbonate solubility at the temperature of the impurity containing stream, the impurity containing stream may be directed to step (a) without treatment with the first precipitant. Typically, such an impurity containing stream would be saturated or close to saturated—including with reference to the common ion effect—with salts such as, but not limited to, lithium carbonate, potassium sulphate or sodium sulphate or contain elevated levels of undesirable metal elements such as, but not limited to, alkali, earth alkali, transition or heavy metals. Alternatively, contaminated treatment process streams such as from lithium carbonate precipitation using a lithium bicarbonate feed solution with elevated levels of impurities may require process stream bleeding. These streams are typically saturated with aqueous lithium carbonate.

The soluble phosphate for step (a) is conveniently an alkali phosphate, preferably sodium phosphate, which allows precipitation of lithium phosphate. Sodium phosphate has a natural pH of about 10.5 and may be generated in a separate unit or in situ by addition of sodium hydroxide to phosphoric acid until effective pH, most preferably about 10.5, for precipitation of lithium phosphate is achieved.

The precipitate containing lithium phosphate may be dissolved with an acid, optionally sulphuric acid or hydrochloric acid, to produce a lithium salt that is recyclable to the lithium extraction process. That is, it may be advantageous, when treating the aqueous impurity stream, to produce a lithium salt which is the same as produced by leaching of a feedstock lithium bearing material, such as an ore, concentrate or other source of lithium. Conveniently, the lithium salt is the target salt from a leaching step of the lithium extraction process. For example, where the acid is sulphuric acid, lithium sulphate is produced by reaction of sulphuric acid with lithium phosphate. If the leaching step also involves sulphuric acid, producing lithium sulphate, the stream from lithium phosphate dissolution may be combined with a lithium sulphate stream from the leaching step, that lithium sulphate stream containing the bulk of the lithium, by mass, in a lithium extraction process. Consequently, the mass of lithium in the stream from lithium phosphate dissolution is substantially less than the mass of lithium in the lithium sulphate stream from the leaching step.

Conveniently, the process is conducted where lithium concentration in the impurity containing stream is above a lower threshold concentration, optionally 100 mg/L or optionally 300 mg/L, at which potential lithium losses may—subject to lithium price—detrimentally affect process economics or, conversely, there would be benefit in recovering the lithium for economic or environmental reasons.

Conveniently, the aqueous impurity stream is produced in a lithium extraction process in which the feedstock lithium bearing material has first been calcined and roasted. While the process may be used in other applications, complications may arise where reagents used to treat the feedstock lithium bearing material, for example an added source of fluorine, themselves create an impurity removal issue, perhaps requiring a multi-stage precipitation process for removal. It is desirable to avoid use of such reagents.

Another aspect of the invention provides a process for extracting lithium comprising the steps of:
(a) extracting lithium in a process generating an aqueous impurity stream containing lithium and impurities;
(b) contacting the aqueous impurity containing stream with a soluble phosphate to produce a precipitate containing lithium phosphate and a soluble impurity containing stream; and
(c) treating the precipitate containing lithium phosphate with an aqueous reagent to produce the soluble phosphate for re-use in step (a) and a lithium salt recyclable to the lithium extraction process.

Conveniently, extracting lithium comprises leaching. However, non-hydrometallurgical processes for extracting lithium may also generate aqueous impurity streams which may be treated as described above.

The process for treating aqueous impurity containing streams, as described above, allows lithium losses in an aqueous impurity containing stream to be substantially reduced with potentially 80% or greater lithium recovery. In addition, the process allows water streams to be produced which have lower lithium content and which, even if discharged as opposed to being totally recycled within the lithium extraction process circuit, as is preferred, are environmentally acceptable.

### BRIEF DESCRIPTION OF THE DRAWINGS

Further features of the process for treating aqueous impurity containing streams of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a flowsheet for a process for producing a lithium salt according to one embodiment of the present invention.

FIG. 2 is a flowsheet for a first embodiment of a process for treating an aqueous impurity containing stream from the process illustrated in FIG. 1.

FIG. 3 is a flowsheet for a second embodiment of a process for treating an aqueous impurity containing stream from the process illustrated in FIG. 1.

### DESCRIPTION OF PREFERRED EMBODIMENTS

### Lithium Extraction Process

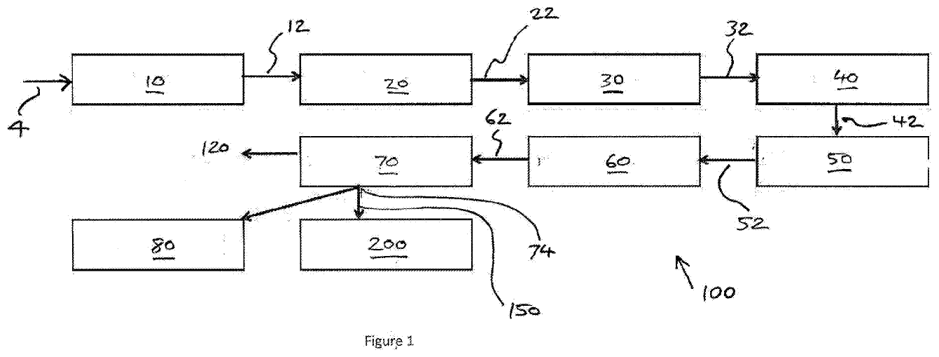

Referring to FIG. 1, there is shown a process 100 for producing a lithium salt 120 suitable for applications such as electric vehicle battery production. The product lithium salt 120 here is lithium carbonate though lithium hydroxide monohydrate is an alternative. Lithium bearing ore or concentrate 4 is calcined in a gas fired rotary kiln in calcination step 10, practised as understood in the art of lithium extraction, to provide a material with mineral 12 microstructure more amenable to leaching in leaching step 20, for example—and in one embodiment—Bβ-spodumene as opposed to α-spodumene though benefit may also be obtained for other lithium bearing materials such as lithium micas. Calcination step 10 may involve roasting of the lithium bearing ore or concentrate with a reagent such as sodium sulphate and/or lime. In preferred embodiments, a source of fluorine would not be added for calcination or in the following leaching step 20 as this would potentially require complex fluorine removal processes.

Leaching step 20 here involves a sulphuric acid leach to produce lithium sulphate though alternative process schemes are available, for example as described in the Applicant's International Publication WO 2023081961, the contents of which are hereby incorporated herein by reference for all purposes. Other acidic leaching agents could be employed in other embodiments.

Lithium containing liquor 22 from leaching step 20 is treated for impurity removal in impurity removal stage 30 following conventional steps such as neutralisation and ion exchange. Multiple ion exchange steps may be required for impurity removal.

Liquor 32, following impurity removal, is then concentrated by evaporation in evaporation step 40 to raise its lithium concentration and produce a concentrated lithium stream 42. Other concentration techniques, such as those based on membrane separation, could be used in other embodiments.

Concentrated lithium stream 42 is then reacted with soda ash (Na₂CO₃) in carbonation step 50 to crystallise a crude solid lithium carbonate 52 which is separated and directed to bicarbonation step 60.

In bicarbonation step 60, a slurry of the crude lithium carbonate 52 in water is treated with ambient or pressurised carbon dioxide in a bicarbonation tank where carbonate ions are transformed to bicarbonate ions, thus solubilising lithium as the more soluble lithium bicarbonate 62 in solution.

Lithium bicarbonate solution 62 is directed to decarbonation step 70 where it is heated to higher than 80° C., and preferably higher than 90° C., to cause decarbonation of the lithium carbonate to produce purified lithium carbonate which is separated to solid lithium carbonate 120 and filtrate 74. The carbon dioxide generated during such heating can then be recovered and re-used in bicarbonation step 60.

Filtrate 74 is directed in part to recover sodium sulphate in sodium sulphate removal step 80 and another part, being an impurity containing or bleed stream 150, is directed for treatment process 200 according to embodiments of the process of the present invention to minimise lithium losses. Bleed stream 150 contains a plurality of impurity cations including potassium, sodium and metals other than lithium and including rubidium and/or caesium; and counter-anions selected from the group consisting of carbonate, bicarbonate, sulphate, and impurities such as bisulphate, sulphide, sulphite, hydroxide, chloride, fluoride, bromide, hydrogen or dihydrogen phosphate, nitrate, thiosulphate, perchlorate, iodate, chlorate, bromate, chlorite, cyanide, amide, cyanate, peroxide, thocyanate, oxalate, hypochlorite, and hypobromite.

It will be understood that bleed streams containing a small quantity of lithium could also be extracted from other parts of the lithium extraction process circuit 100. In embodiments, the various impurity containing streams can—subject to chemical composition—be combined for lithium recovery according to the scheme described below.

### Treatment of Impurity Containing Stream

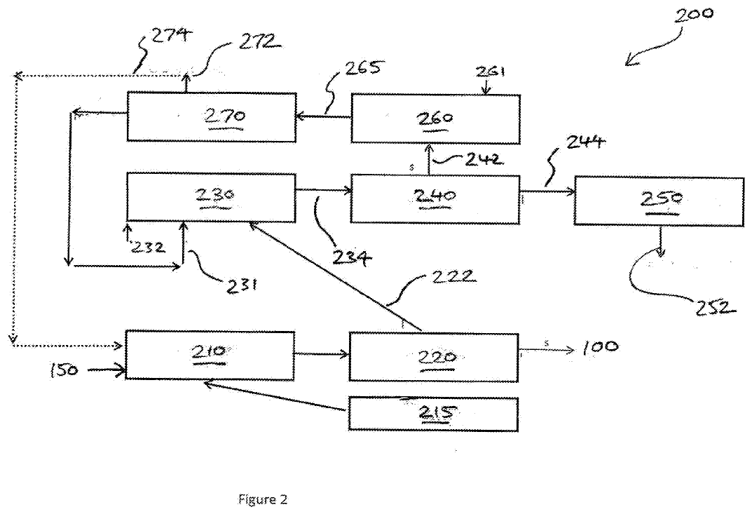

In one embodiment, the bleed stream 150 contains more than 2.5 g/L lithium, and is amicable to lithium carbonate precipitation upon reaction with sodium carbonate in lithium carbonate precipitation step 210 as indicated in FIG. 2. High levels of lithium in potential bleed streams may, for example, be a result of pre-concentration by evaporation or by a membrane technology such as reverse osmosis. In this case the bleed stream 150 is reacted with sodium carbonate 215 at a temperature higher than 20° C. at a stoichiometric ratio equal to or higher than (typically between 5 and 10%) the molar quantities of cations able to form their respective carbonate crystals. The generated solid material from a typical lithium processing stream will mainly be composed of lithium carbonate, for example stream 52. Where lithium sulphate is produced in leaching step 20, the reaction below would produce lithium carbonate:

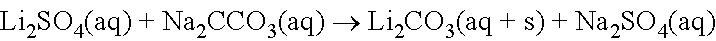

The residual lithium concentration of filtrate 222 will be determined by the solubility limit of lithium carbonate at the reaction temperature, the solubility limit or saturation concentration typically ranging from 1.6 g/L lithium to 2.8 g/L lithium dependent on reaction temperature. The generated lithium carbonate slurry may be filtered in filtration step 220 by any method suitable for industrial filtration such as, but not limited to, pressure filtration in candle filters or plate and frame filters, or centrifugation to recover precipitated lithium carbonate.

The filtrate 222 from filtration step 220, saturated with lithium carbonate, is directed to sodium phosphate treatment step 230 as described further below. The precipitated lithium carbonate may be recycled to the process 200, for example as an offset of sodium carbonate for calcium removal, or it may be reacted with sulphuric acid to produce lithium sulphate that can be added to the lithium sulphate containing liquor 22 from leaching step 20.

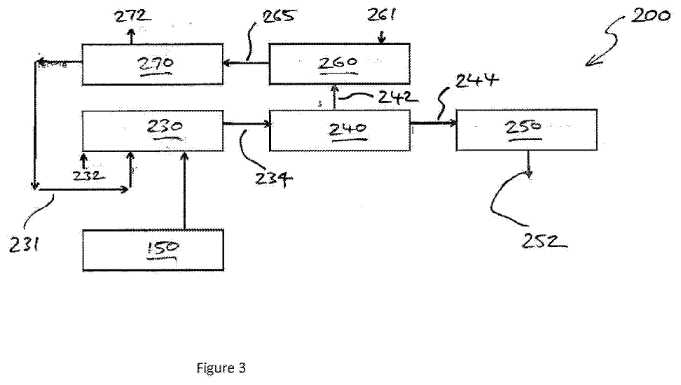

In an alternative embodiment, the bleed stream 150 contains 2.5 g/L lithium or less such as the case of lithium carbonate precipitation from impurity heavy process streams. Typically, the bleed stream 150 would be saturated or close to saturated with salts such as, but not limited to, potassium sulphate or sodium sulphate. The bleed stream 150 could contain elevated levels of undesirable metal elements such as, but not limited to, alkali, alkaline earth, transition or heavy metals. Alternatively, contaminated process streams, such as from lithium carbonate precipitation using a lithium carbonate feed solution with elevated levels of impurities, may require process stream bleeding. These streams are typically saturated with aqueous lithium carbonate. Such bleed streams 150 can thus be fed directly to the sodium phosphate treatment step 230 and treated in treatment process 200 as shown in FIG. 3.

In the sodium phosphate treatment step 230, whether of FIG. 2 or FIG. 3, the saturated lithium carbonate solution—typically having solubility limit or saturation concentration typically ranging from 1.6 g/L lithium to 2.8 g/L lithium dependent on reaction temperature—is contacted with a stoichiometric excess of sodium phosphate, either purchased or produced by reaction of phosphoric acid 231 and sodium hydroxide 232 to precipitate sodium phosphate. The process conditions for precipitation of sodium phosphate are, for example, a temperature exceeding 40° C., preferably 80° C., more preferably 90° C. or higher, and a residence time of at least 0.25 hour, preferably 0.5 hour, or more, depending on the feed composition.

The sodium phosphate slurry 234 is filtered in filtration step 240 by any method suitable for industrial filtration such as, but not limited to, pressure filtration in candle filters or plate and frame filters or centrifugation. Any of these filtration steps 240 may be preceded by increasing the solids density of sodium phosphate slurry 234 by thickening in a process thickener. The concentration of lithium in the liquor is thus decreased from the 2±0.5 g/L of bleed stream 150 to approximately 0.1±0.05 g/L in the filtrate 244 when conducted at 90≅ C., thus recovering more than 80% of the lithium in the bleed stream as shown in the following reaction scheme:

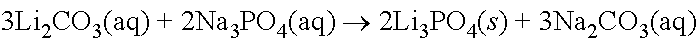

Reducing the temperature for this reaction causes an increase in the lithium concentration of treated filtrate 244, for example at 80° C., the concentration is 125±0.05 g/L. Additionally, and depending on the amount of impurities in the bleed stream 150, an alternative embodiment may include further evaporation of the filtrate 244 to increase the yield of solid or recoverable lithium phosphate from the above reaction prior to process water treatment step 250. Performing the sodium phosphate treatment step 230 provides a clear separation of lithium from other monovalent ions present in the stream, such as sodium and potassium, which have substantially higher solubility in water; however, divalent ions—such as iron, calcium and magnesium—will also precipitate to a large degree. However, the issue of cation impurity removal is typically addressed to substantial extent in most conventional lithium extraction processes by ion exchange or precipitation steps upstream from bleed stream 150 to remove the divalent ions.

The source of sodium phosphate for sodium phosphate treatment step 230 may be commercial or, alternatively, phosphoric acid recycled from downstream processing may be reacted with sodium hydroxide—optionally and with possible benefit in a dedicated vessel—to produce sodium phosphate as follows:

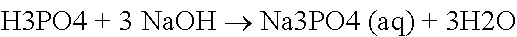

The filtrate 244 from the filtration step 240 is then fed to a process water treatment step 250, such as a brine concentrator 250 for aqueous brine disposal. Alternatively, the filtrate 244 is fed to a zero liquor discharge unit 250 from where an anhydrous salt mixture 252 is obtained for disposal or sale. Options for the zero liquor discharge (ZLD) unit 250 are commercially available. Condensate from the brine concentrator or zero liquor discharge unit 250 may be returned to process 100 or 200 to optimise the water balance.

Precipitated and filtered lithium phosphate 242 is treated in phosphoric acid regeneration step 260 to recover phosphoric acid 231 for use in sodium phosphate treatment step 230. In the embodiment shown, lithium phosphate 242 is treated at ambient, or higher, temperatures with sulphuric acid 261 to dissolve lithium phosphate 242 and generate a stream 265 containing a lithium sulphate and phosphoric acid slurry. The reaction scheme is as follows:

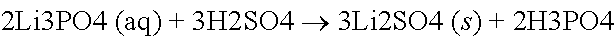

Lithium sulphate may be largely separated from the phosphoric acid 231 in separation step 270 by any method suitable for industrial filtration such as, but not limited to, pressure filtration in candle filters or plate and frame filters, or centrifugation. Any of these filtration steps may be preceded by increasing the solids density of the stream or slurry 265.

The filtered lithium sulphate may be returned to process 100 as lithium sulphate stream 272 or, in the case of conducting initial lithium carbonate precipitation step 210 as shown in FIG. 2, recycled as lithium sulphate stream 274 to the lithium carbonate precipitation step 210. Lithium sulphate 272 is compatible with the process since leaching step 20 produces lithium sulphate. It will be appreciated that the lithium sulphate stream contains lesser mass of lithium than lithium containing liquor 22 from leaching step 20.

The process 200 for treating aqueous impurity containing streams, such as bleed stream 150 as described above, allows lithium losses in the aqueous impurity containing stream to be substantially reduced. In addition, the processes 100, 200 allow water streams to be produced which have lower lithium content and which, even if discharged as opposed to being totally recycled within the lithium extraction process circuit, as is preferred, are environmentally acceptable.

Those skilled in the art will appreciate that the process of the invention described herein is susceptible to variations and modifications other than those specifically described. The invention includes all such variation and modifications. The invention also includes all of the steps and features referred to or indicated in the specification, individually or collectively and any and all combinations or any two or more of the steps or features. In particular, the process allows recovery of lithium from a bleed stream from a lithium extraction process allowing losses inherent in previous processes to be reduced or even eliminated.

Throughout this specification, unless the context requires otherwise, the word “comprise” or variations such as “comprises” or “comprising”, will be understood to imply the inclusion of a stated integer or group of integers but not the exclusion of any other integer or group of integers.

The process of the present invention described herein may include one or more range of values (e.g. temperature, time, pressure etc). A range of values will be understood to include all values within the range, including the values defining the range, and values adjacent to the range which lead to the same or substantially the same outcome as the values immediately adjacent to that value which defines the boundary to the range.

The process of the present invention is not to be limited in scope by any of the specific embodiments described herein. These embodiments are intended for the purpose of exemplification only. Functionally equivalent methods are clearly within the scope of the invention as described herein.

1. A process for treating aqueous impurity containing streams containing lithium cations and impurities within a lithium extraction process comprising:
(a) contacting the impurity containing stream with a soluble phosphate to produce a precipitate containing lithium phosphate and a soluble impurity containing stream; and
(b) treating the precipitate containing lithium phosphate with an aqueous reagent to produce the soluble phosphate for re-use in step (a) and a lithium salt recyclable to the lithium extraction process.

2. The process of claim 1, wherein the impurity containing stream is a stream removed from the lithium extraction process for the purposes of reducing impurity build up in a lithium extraction process circuit.

3. The process of claim 1, wherein the impurity containing stream contains a plurality of impurity cations selected from the group consisting of potassium, sodium and metals other than lithium; and counter-anions selected from the group consisting of carbonate, bicarbonate, sulphate, bisulphate, sulphide, sulphite, hydroxide, chloride, fluoride, bromide, hydrogen or dihydrogen phosphate, nitrate, thiosulphate, perchlorate, iodate, chlorate, bromate, chlorite, cyanide, amide, cyanate, peroxide, thiocyanate, oxalate, hypochlorite, and hypobromite.

4. The process of claim 1, wherein the impurity containing stream is treated with a first precipitant prior to step (a) to produce a precipitate containing a lithium salt when lithium concentration in the impurity containing stream is above a threshold.

5. The process of claim 4, wherein said threshold is the lithium carbonate solubility at the temperature of the impurity containing stream.

6. The process of claim 4, wherein, for lower pH solutions, the first precipitant is a carbonate.

7. The process of claim 6, wherein the lower pH solution is a sulphate or chloride system.

8. The process of claim 4, wherein, for higher pH solutions, the first precipitant is carbon dioxide gas.

9. The process of claim 8, wherein the higher pH solution is a hydroxide system.

10. The process of claim 1, wherein the impurity containing stream is directed to step (a) without treatment with a first precipitant when lithium concentration in the impurity containing stream is below a threshold.

11. The process of claim 10, wherein said threshold is the lithium carbonate solubility at the temperature of the impurity containing stream.

12. The process of claim 11, wherein said impurity containing stream is saturated or close to saturated, with reference to the common ion effect, with salts selected from the group consisting of lithium carbonate, potassium sulphate and sodium sulphate.

13. The process of claim 11, wherein said impurity containing stream contains elevated levels of undesirable metal elements selected from the group consisting of alkali, earth alkali, transition and heavy metals.

14. The process of claim 1, wherein the soluble phosphate for step (a) is an alkali phosphate.

15. The process of claim 14, wherein process conditions for precipitation of sodium phosphate are a temperature exceeding 40° C. and a residence time of at least 0.5 hour, depending on feed composition.

16. The process of claim 1, wherein the precipitate containing lithium phosphate is dissolved with an acid selected from the group comprising at least one of sulphuric acid and hydrochloric acid to produce a lithium salt that is recyclable to the lithium extraction process.

17. The process of claim 16, wherein said lithium salt is combined with a stream from leaching of a lithium bearing material.

18. The process of claim 17, wherein the stream from lithium phosphate dissolution is combined with a lithium sulphate stream from the leaching step when leaching of the lithium bearing material involves sulphuric acid, producing lithium sulphate.

19. The process of claim 1, wherein lithium concentration in the impurity containing stream is above a threshold concentration of 100 mg/L.

20. The process of claim 17, wherein said lithium bearing material is calcined prior to leaching.

21. The process of claim 20, wherein said lithium bearing material is calcined in the absence of an added source of fluorine.

22. A process for extracting lithium comprising the steps of:
(a) extracting lithium in a process generating an aqueous impurity containing stream;
(b) contacting the aqueous impurity containing stream with a soluble phosphate to produce a precipitate containing lithium phosphate and a soluble impurity containing stream; and
(c) treating the precipitate containing lithium phosphate with an aqueous reagent to produce the soluble phosphate for re-use in step (a) and a lithium salt recyclable to the lithium extraction process.

23. The process of claim 22, wherein extracting lithium comprises leaching.
